(19) United States
(12) Patent Application Publication
(10) Pub. No.: US 2013/0326143 A1
(43) Pub. Date: Dec. 5, 2013

(54) Caching Frequently Used Addresses of a Page Table Walk

(71) Applicant: Wei-Hsiang CHEN, Sunnyvale, CA (US)

(72) Inventor: Wei-Hsiang CHEN, Sunnyvale, CA (US)

(73) Assignee: Broadcom Corporation, Irvine, CA (US)

(21) Appl. No.: 13/486,713

(22) Filed: Jun. 1, 2012

(51) Int. Cl. G06F 12/08

(52) U.S. Cl. 711/122; 711/E12.024

(57) ABSTRACT

An architecture and method are described for performing memory management. A page walker cache is provided to cache data used during the page walk process. This cache structure speeds up the page walk process, which significantly reduces the expense of performing a page walk. The page walker cache also reduces the cost associated with usage of memory access bandwidths.

This disclosure concerns architectures and methods for implementing memory management.

### BACKGROUND OF THE INVENTION

A computing system utilizes memory to hold data that is used perform its processing, such as instruction data or computation data. The memory is usually implemented with semiconductor devices organized into memory cells, which are associated with and accessed using a memory address. The memory device itself is often referred to as “physical memory” and addresses within the physical memory are referred to as “physical addresses” or “physical memory addresses”.

Many computing systems also use the concept of “virtual memory”, which is memory that is logically allocated to an application on a computing system. The virtual memory corresponds to a “virtual address” or “logical address” which maps to a physical address within the physical memory. This allows the computing system to de-couple the physical memory from the memory that an application thinks it is accessing. The virtual memory is usually allocated at the software level, e.g., by an operating system (OS) that takes responsibility for determining the specific physical address within the physical memory that correlates to the virtual address of the virtual memory.

A memory management unit (MMU) is the component that is implemented within a processor, processor core, or central processing unit (CPU) to handle accesses to the memory. One of the primary functions of many MMUs is to perform translations of virtual addresses to physical addresses. When there is a request to access data in memory, the memory request may be associated with virtual memory address, which is translated by the MMU into a physical memory to perform the memory access within the memory device.

A general address cache may be used by the MMU to quickly perform address translations. The address cache is usually implemented as a translation lookaside buffer (TLB). In general, a TLB is used to reduce virtual address translation time, and is often implemented as a table in a processor's memory that contains information about the pages in memory that have been recently accessed. Therefore, the TLB functions as a cache to enable faster computing because it caches a mapping between a first address and a second address.

If a given memory access request from an application does not correspond to mappings already cached within the TLB, then this cache miss will require much more expensive operations by the MMU to perform the address translation. A page walker mechanism is used to access page table entries within one or more page tables to perform address translations. Once the page walker has performed the address translation, the translation data can be stored within the TLB 304 to cache the address translation mappings for a subsequent memory access for the same address values.

The problem is that requiring a MMU to use a page walker to perform the address translation is very computationally expensive. Much of the expense is incurred by the requirement to perform memory access to load and process the page tables. A significantly large number of instructions cycles may be needed to perform each individual address lookup using the page walk process, both to perform the memory accesses and to actually handle the instructions to perform the page walk. In addition to these computation and memory access costs, the page walk process may also consume a significant amount of cache bandwidth.

Therefore, there is a need for an improved approach to implement memory management which can more efficiently perform memory access in a virtualization environment.

### BRIEF SUMMARY OF THE INVENTION

The present disclosure describes an architecture and method for performing memory management. According to some embodiments, a page walker cache is provided to cache data used during the page walk process. This cache structure speeds up the page walk process, which significantly reduces the expense of performing a page walk. The page walker cache also reduces the cost associated with usage of memory access bandwidths.

Further details of aspects, objects, and advantages of various embodiments are described below in the detailed description, drawings, and claims. Both the foregoing general description and the following detailed description are exemplary and explanatory, and are not intended to be limiting as to the scope of the disclosure.

### BRIEF DESCRIPTION OF THE DRAWINGS/FIGURES

The drawings illustrate the design and utility of embodiments, in which similar elements are referred to by common reference numerals. In order to better appreciate the advantages and objects of various embodiments, reference should be made to the accompanying drawings. However, the drawings depict only certain embodiments, and should not be taken as limiting the scope of the disclosure.

FIG. 1 illustrates an example system for performing address translations according to some embodiments.

FIG. 2 illustrates a page walker cache in the context of a hierarchical tree for page table structures according to some embodiments.

FIG. 3 shows a flowchart of an approach for performing address translations using a page walker cache according to some embodiments.

FIG. 4 illustrates a multi-level page walker cache in the context of a hierarchical tree for page table structures according to some embodiments.

FIG. 5 shows a flowchart of an approach for performing address translations using a multi-level page walker cache according to some embodiments.

FIG. 6 illustrates an example computer system in which an embodiment of the invention, or portions thereof, can be implemented.

### DETAILED DESCRIPTION OF THE INVENTION

This disclosure describes improved approaches to perform memory management.

According to some embodiments, a page walker cache is provided to cache data used during the page walk process. This cache structure speeds up the page walk process, which significantly reduces the expense of performing a page walk. The page walker cache also reduces the cost associated with usage of memory access bandwidths.

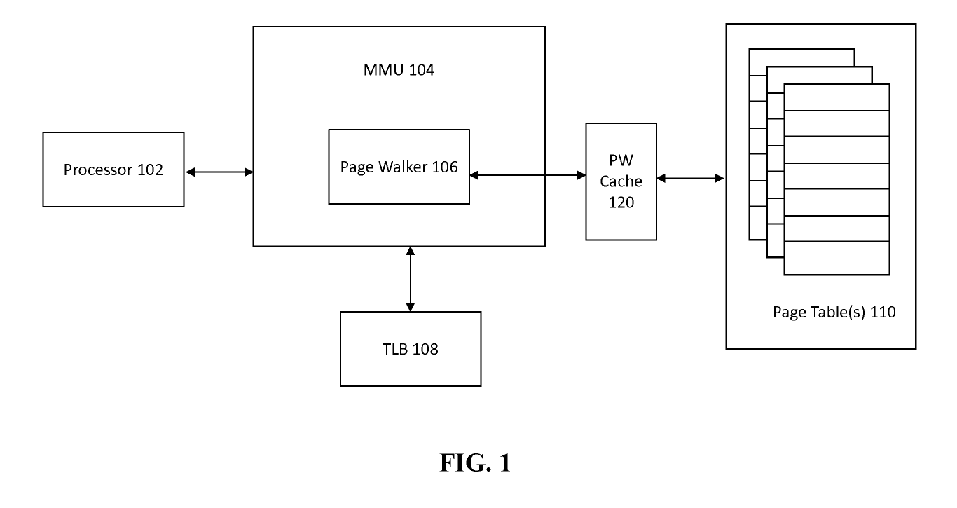

FIG. 1 illustrates a memory management system according to some embodiments. A Memory Management Unit (MMU) 104 is associated with each processor 102 (or with each core in a multi-core processor/CPU). Each MMU 104 is associated with one or more on-chip translation look-aside buffers (TLBs) 108 to translate virtual addresses into physical addresses. The TLB 108 is implemented in the processor's memory and contains information about the pages in memory that have been recently accessed. Therefore, the TLB 108 functions as a cache to enable faster computing because it caches a mapping between a virtual address and a physical address.

Multiple types of TLBs 108 may be used in conjunction with the MM 104. For example, a joint TLB (JTLB) can be used for both instruction and data translations, providing fully associative mapping of virtual pages to their corresponding physical addresses. Some systems may also implement a separate Data TLB (DTLB) and Instruction TLB (ITLB). These structures improve performance by allowing instruction address translation and data address translation to occur in parallel. This minimizes contention for the JTLB, and can reduce efficiency losses due to timing-critical path of translating through a large associative array. Both the DTLB and the ITLB are filled from the JTLB when a miss occurs.

If a given memory access request from an application does not correspond to mappings cached within the TLB 108, then this cache miss/exception will require much more expensive operations by a page walker 106 to access page table entries within one or more page tables 110 to perform address translations. The results of the address translation are then cached as entries into the TLB 108.

In general, the page tables 110 are organized as a multi-level hierarchical tree, which the page walker 106 traverses in a top-down manner to perform an address translation. Each level of the hierarchical tree typically corresponds to a separate set of work that must be performed by the page walker 106 to load the page structure for that level of the tree, and to then process that page structure to locate an entry that points to another page structure in a subsequent level of the hierarchical tree. This process proceeds through each level of the hierarchical tree until the final level of the hierarchical tree is processed to obtain the physical address.

A page walker cache 120 is provided in some embodiments to improve the efficiency of the page walk operation. The page walker cache 120 holds memory content for the page walk process that can be more quickly and efficiently accessed by the MMU 104. This means that data which would otherwise need to be extracted at a given hierarchical level of the hierarchical page table tree using a page walk process would instead be cached within the page walk cache 120. This greatly reduces the amount of work that must be performed by the page walker 106 to process a given level of the hierarchical tree. The page walker cache may be implemented at any level of the hierarchal tree.

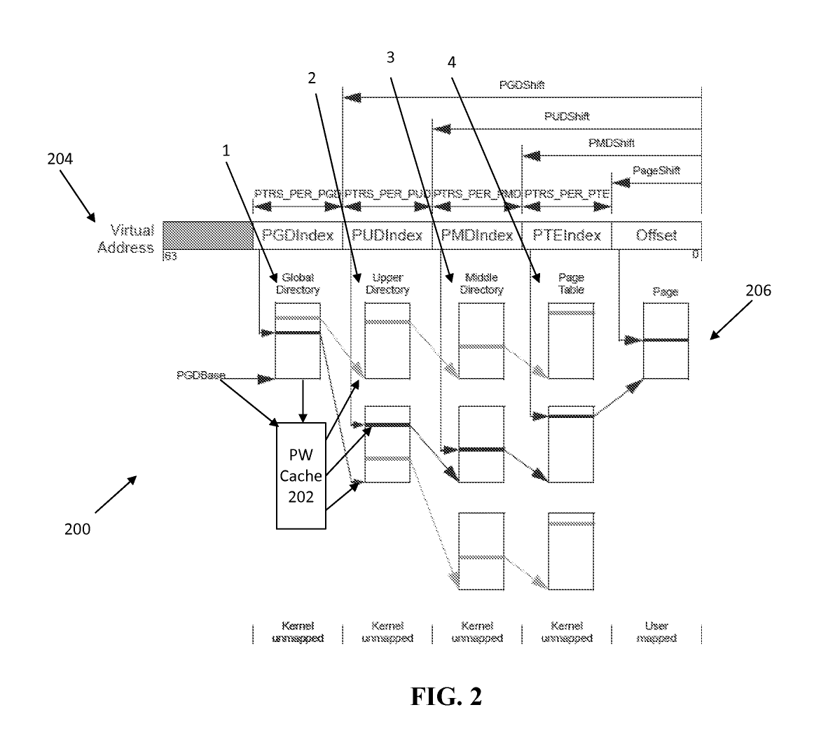

FIG. 2 shows an example of a four-level page table hierarchy 200 that can be used to translate a virtual address 204 into a physical address 206. The first (and top-most) level 1 of the hierarchical tree 200 is the Page Global Directory (PGD). The second level 2 of the tree 200 is the Page Upper Directory (PUD). The third level 3 of the hierarchical tree 200 is the Page Middle Directory (PMD), and the fourth level 4 is the Page Table (PTE). While this particularly hierarchical tree 200 is described in the document for purposes of explanation, it is expressly noted that the present embodiments may be applicable to any type of hierarchical tree structure for a page walk, and is not limited the specific structures disclosed herein unless claimed as such.

The virtual address 204 is used by the page walker to identify an entry in the Page Global Directory (PGD) at level 1 of the hierarchical tree 200. The identified entry in the PGD provides an index into the Page Upper Directory at level 2 of the hierarchical tree 200, to locate an entry which points to an entry in the Page Upper Directory. The PUD entry at level 2 of the tree 200, in turn, point to an entry in the PMD at level 3 of the hierarchical tree 200. The PMD entry points to a page table entry in the page tables at level 4 of the hierarchical tree 200. The identified entry in the page table at level 4 provides a pointer to the physical address within the memory.

The root of the hierarchical tree structure 200 is the Page Global Directory at level 1, which can be implemented as a page-sized array. This directory is indexed by the PGDIndex field of the virtual address 204. The pointer to the root of the table (referred to herein as the “PGDBase”) for each process is stored in a fixed register or at a fixed memory location by the kernel when it schedules the process. Each entry of the PGD at level 1 is a pointer to a page-sized array of the Page Upper Directory at level 2, which is indexed by the PUDIndex field in the virtual address 204. Each entry of the PUD at level 2, in turn, is a pointer to a page-sized array in the Page Middle Directory at level 3, which is indexed by the PMDIndex field in the virtual address 204. Each entry in the PMD at level 3 is a pointer to an actual page-sized page table at level 4 containing page-table entries. As with the other index fields in the virtual address, a shift field (referred to herein as “PAGEShift”) determines the location of the page index field PTEIndex in the virtual address 204.

While this illustrative example of a four-level table structure 200 is being described for purposes of explanation, it is noted that the embodiments of this disclosure may be applied to tree structures having any number of hierarchical levels. For example, a page table organization with fewer levels can achieved, e.g., by folding the PUD and the PMD levels into a single level. Thus, a three-level structure is achievable by folding the PUD so that the hierarchy consists of the PGD, PMD and page tables. Similarly, a two-level structure can be obtained by folding both the PUD and the PMD so that the hierarchy consists of just the PGD and page tables. PGDShift, PUDShift, PMDShift, PAGEShift are shift values to determine the location of an index field in the virtual address 204, and can be maintained by the kernel as hard-coded macros.

Once the page walker has traversed the table structure 200, and accessed the page specified by the PTEIndex, it reads the indicated values to obtain the physical address. For example, the pages specified by the PTEIndex may be two 64-bit values from an Offset and an Offset+8, which are 64-bit words that can be shifted by a specified amount, and presented as the low- and high-order TLB entries. For unallocated pages, all levels of page tables will contain valid entries but the final PTE entry will have its valid bit cleared.

The page walker processes TLB misses in hardware without taking a refill exception, by locating the requested TLB entry and installing it in the TLB. This means that the page walker essentially performs TLB look-up with variable latency. In some embodiments, the page walker is implemented purely in hardware, while other embodiments may implement the page walker using both hardware and software. There is one hardware page walker per thread, each capable of handling one request per thread.

The page walker processing will involve nontrivial computational expenses, including expenses associated with sets of instructions to process the page structures, such as adds, shifts, etc. However, the major component of the performance cost for a page walk operation is the cost of performing memory access to load and access the tables associated with the different levels of the hierarchical tree 200. A cold start of a 4 level page walk can consume a significantly large number of cycles to complete, with the memory access needed to get data from a DRAM, and may also excessively steal some memory cache bandwidth.

One or more page walker cache(s) are provided to reduce the expenses of performing a page walk. In the example of FIG. 2, a page walker cache 202 is provided at the root level 1 of the hierarchical tree 200. The general idea is that every page walk will, as a starting point for the page walk process, necessarily and universally traverse the same set of entries within the global directory at level 1 of the tree 200. Therefore, page walker cache 202 will be used to cache the entries from the Page Global Directory so that this set of information does not need to be loaded each and every time a page walk occurs. This will avoid a significant amount of the expense associated with performing a page walk.

The lower part of the page walk process (e.g., to obtain memory content used as a pointer to the next level) will be used by different page walk multiple times, and hence can be cached in the page walker cache(s) to perform performance. Therefore, the page walker cache provides the sought-after memory content in a computationally closer location, which limits the number of external memory accesses that need to be performed. In some embodiments, the page walker cache is not tied to a given spatial locality like conventional cache design.

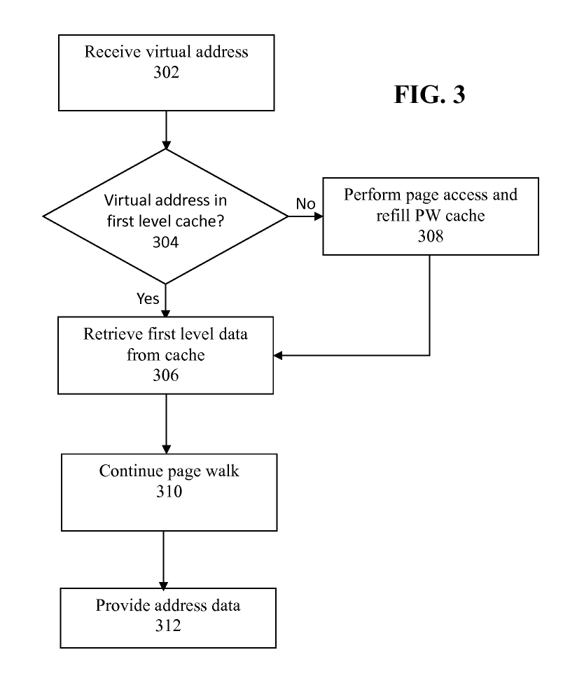

FIG. 3 shows a flowchart of an approach for utilizing a page walker cache. At 302, a virtual address is received for translation. This occurs, for example, when software that uses the processor (such as the kernel within an operating system) needs to perform some type of memory access operation. For example, an operating system may have a need to access a memory location that is associated with a virtual address. It is assumed that a check is made whether a mapping exists for that virtual address within the TLB, and that a cache miss occurred causing a page walk process to be performed. In this circumstance, the page walker will conventionally need to traverse an entire hierarchical page tree structure to translate the virtual address into a physical address.

At 304, the page walker cache is checked for the top level of the hierarchical tree. The page walker cache includes one or more memory structures to maintain pointers that point to entries within the next level of the hierarchical tree. If the requested information exists in the page walker cache, then that information is retrieved at 306.

If that data is not present in the cache, then a cache miss occurs, and at 308 the conventional page access process is performed to obtain the necessary information, which is then loaded into the page walker cache.

In some embodiment, the cache miss should not occur since the cache is re-built whenever an event occurs that would have invalidated the cache. For example, in some systems, the pointer in the first level page walker cache changes only when domains (described in more detail below) are re-partitioned, and the first level page walker cache is rebuilt whenever such an event occurs. Therefore, a cache miss should not normally occur for the first level page walker cache. The first level page walker cache is therefore maintained as a relatively static cache that will not normally be updated during page walks.

At this point, a pointer has been retrieved from the first level page walker cache which identifies an entry in the next level of the hierarchical tree that needs to be retrieved to continue the page walk process. Therefore, at 310, the page walk process continues through the rest of the hierarchical tree. At the end of the page walk, the actual offset within the page in memory is identified for the virtual address of interest. At 312, that physical address is provided to perform the originally requested memory access operation.

While this example flow only describes a page walker cache for only a single level of the hierarchical tree, it is noted that the present approach can be applied to provide a page walker cache for any number of levels of the hierarchical tree. The trade-off to be considered is the cost that is required to allocate and maintain memory needed for the page walker cache(s) versus the performance benefit to be obtained for having the cache(s).

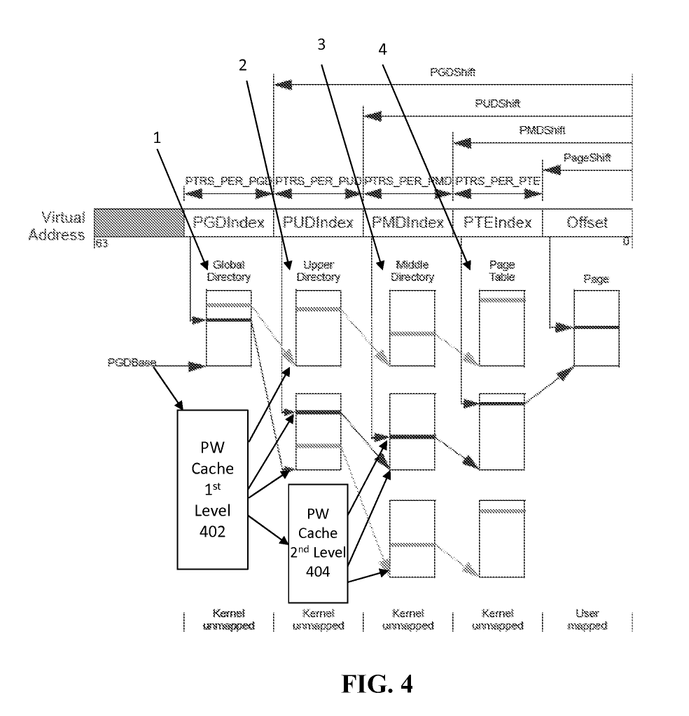

FIG. 4 illustrates an example in which page walker caches are provided for the first two levels of the hierarchical tree. A first page walker cache 402 is provided for the first (top-most) level of the hierarchical tree, and a second cache 404 is provided for the second level of the hierarchical tree.

The first page walker cache 402 is provided at the root level 1 of the hierarchical tree so that Page Global Directory does not need to be loaded each and every time a page walk occurs. Instead, the entries from the Page Global Directory are cached in the first level page walker cache 402.

The cached information in the first page walker cache 402 provides pointers to entries within the page Upper Directory at the second level of the hierarchical tree. Normally, the appropriate tables within the Page Upper Directory at the second level of the hierarchical tree would need to be loaded and processed to continue the page walk. However, the approach of FIG. 4 provides a second level page walker cache 404 to cache data from the Page Upper Directory.

If the requested entry from the page Upper Directory is cached within the page walker cache 404, then the requested information can be immediately obtained from the page walker cache 404, without resorting to the expensive process of loading the Page Upper Directory from memory to obtain the necessary directory entry. The normal page walk process at the second level of the directory tree to load and process tables from the Page Upper Directory will only be necessary if the requested entries are not cached in the page walker cache 404.

In some embodiments, the first level page walker cache 402 contains 8 memory elements to hold content, which holds pointers to the 2nd level of the hierarchical tree. This approach is taken for a page walker cache design that assumes that the OS kernel will divide a full address into 32 domains (e.g., including kernel, super user, and user segments). The OS kernel would assign the 2nd level page walker pointer to each domain, where pointers only change when the domains are re-partitioned. Since the 1st level of page walker cache has includes 8 entries, it can be evicted from 1st level page walker cache if there is an address aliasing. The 1st level of Page Walker Cache corresponds to a virtual address (VA) tag (e.g., 1R1W1C 8×32×4) with a 4 GB page size boundary for TLB shoot-down. A physical address (PA) tag (e.g., 1R1W1C 8×40×4) is employed, with a 64 B cache-line size boundary for probe invalidations. Data array (e.g., 1R1W 8×64×4) and Position Array (e.g., 8×2×4 flops) elements are used for indicate which alias is valid. A Valid Array structure (e.g., 8×1×4 flops) is also provided. The VA tag is used to invalidate the page walker cache due to a change in the mapping between a VA and a PA. The PA tag is used to invalidate the page walker cache due to a segments's PGD base change.

The 1st level page walker cache will cache each segment's PGD base. Each thread within a processor (or core) can use up to 8 segments without any PGD base replacement. The VA will be divided up 32 segments by the OS kernel, with each segment having its own PGD base. The page walker cache is indexed by segment number, and is direct mapped with an alias on lower bits on the segment number.

The second level page walker cache 404 contains pointers to the 3/4/5 level of the hierarchical tree (depending upon specific tree configurations). In some embodiments, the second level page walker cache is formed of a memory structure having 32 entries. The second level page walker cache corresponds to a VA tag (e.g., 1R1W1C 32×32 and 1R1W1C 32×32) and has a 4 GB page size boundary for TLB shoot-down and a 8 B line size boundary for the second page walker cache look-up. The PA tag (e.g., 1R1W1C 32×40) has a 64 B cache-line size boundary for probe invalidations. The second level cache corresponds to a Data Array (e.g., 1R1W 32×64), and a Valid Array (e.g., 32×1) that caches a PUD entry (and possibly PMD/PTE base depending upon the tree configuration), with 32 entries shared by 4/2/1 threads for the processor/core. The second level cache can be fully associative, where a VA tag is used to perform look-ups due to the fact that it does not need VA to PA translations. The VA tag is used to invalidate the page walker cache due to VA to PA mapping changes. The PA tag is used to invalidate the page walker cache due to PUD/PMD/PTE base changes.

In some embodiments, the second level cache implements a LRU (least recently used) replacement policy, where the least recently used entries within the cache are replaced with newly identified entries from the page walk process.

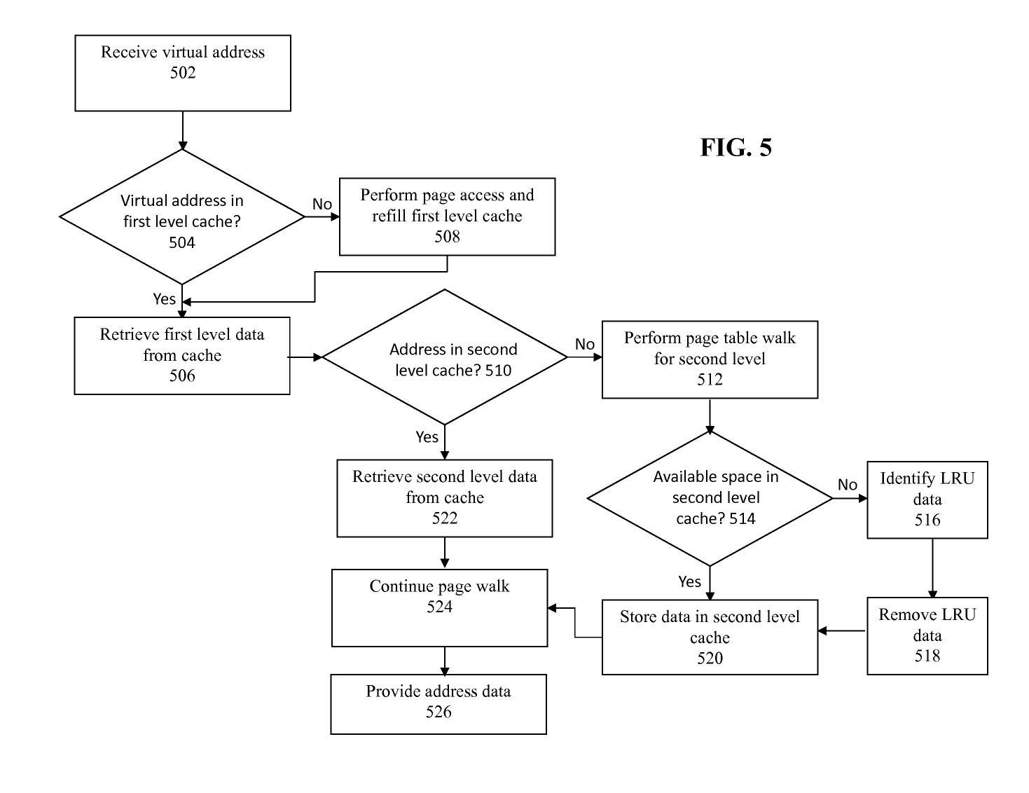

FIG. 5 shows a flowchart of an approach to perform a page walk in conjunction with a multi-level page walker cache. At 502, a virtual address is received for translation. This occurs, for example, when software that uses the processor (such as the kernel within an operating system) needs to perform some type of memory access operation. For example, an operating system may have a need to access a memory location that is associated with a virtual address.

It is assumed that a check is made whether a mapping exists for that virtual address within the TLB, and that a cache miss occurred causing a page walk process to be performed. In this circumstance, the page walker will need to traverse the hierarchical page tree structure to translate the virtual address into a physical address. It is further assumed that a multi-level page walker cache exists to cache entries for the top level(s) of the hierarchal tree.

At 504, the first level page walker cache is checked for the top level of the hierarchical tree. The page walker cache includes one or more memory structures to maintain pointers that point to entries within the next level of the hierarchical tree. If the requested information exists in the page walker cache, then that information is retrieved at 506. If that data is not present in the cache, then a cache miss has occurred, and the top level page structures will need to be loaded and processed to identify the required entries, which is then loaded into the page walker cache. The entry is then obtained from the first level page walker cache at 506. At this point, a pointer has been retrieved from the first level page walker cache which identifies the entry in the next level of the hierarchical tree that needs to be retrieved to continue the page walk process.

Thereafter, at 510, the second level page walker cache is checked for the second level of the hierarchical tree. The page walker cache includes one or more memory structures to maintain pointers for the second level of the hierarchical tree, which point to entries within the third level of the hierarchical tree. If the requested information exists in the second level page walker cache, then that information is retrieved at 522.

If the necessary information is not present in the second level page walker cache, then a cache miss has occurred. Therefore, the conventional page walk process is performed at 512 for the second level of the hierarchical tree to obtain the required information. This information includes a pointer entry that points to the next level of the hierarchical tree.

At 514, a check is made whether there is sufficient space in the second level page walker cache to store the newly retrieved information. If so, then that information is immediately stored into the second level page walker cache. If not, then at 516, an LRU algorithm is applied to identify the least recently used data from within the second level page walker cache. At 518, the identified data in the second level page walker cache (the least recently used data) is then removed from the cache. At 520, the newly retrieved data is then stored into the second level page walker cache.

At this point, a pointer has been retrieved at the second level of the hierarchical tree that identifies an entry in the next (third) level that needs to be retrieved to continue the page walk process. At 524, the page walk process continues through the rest of the hierarchical tree. At the end of the page walk, the actual offset within the page in memory is identified for the virtual address of interest. At 526, that physical address is provided to perform the originally requested memory access operation.

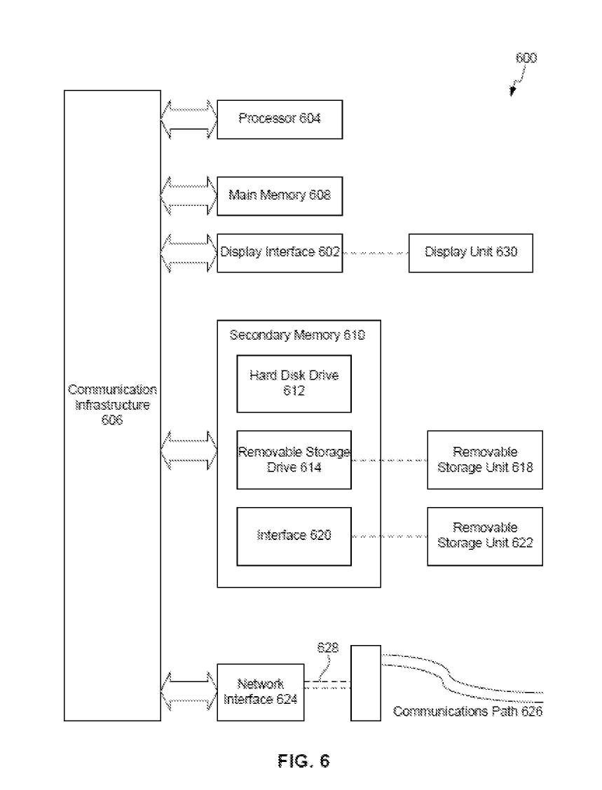

Various aspects of the present invention can be implemented by software, firmware, hardware, or a combination thereof. FIG. 6 illustrates an example computer system 600 in which the present invention, or portions thereof, can be implemented as computer-readable code. For example, the methods illustrated by the flowcharts of FIG. 3 and FIG. 5, as well as page walker 106 of FIG. 1, can be implemented in system 600. Various embodiments of the invention are described in terms of this example computer system 600. After reading this description, it will become apparent to a person skilled in the relevant art how to implement the invention using other computer systems and/or computer architectures.

Computer system 600 includes one or more processors, such as processor 604.

Processor 604 can be a special purpose or a general purpose processor. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612, a removable storage drive 614, and/or a memory stick. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. that is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 that allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals that may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, and a hard disk installed in hard disk drive 612. Signals carried over communications path 626 can also embody the logic described herein. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the methods illustrated by flowcharts 300 of FIG. 3, 400 of FIGS. 4, and 500 of FIG. 5, discussed above. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

Therefore, what has been described is an improved approach for implementing memory management, where one or more levels of a page walker cache is provided to cache data used during the page walk process. This cache structure speeds up the page walk process and also saves memory access bandwidth.

In the foregoing specification, examples of embodiments have been described. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting their scope or operation. The specification and drawings are, accordingly, to be regarded in an illustrative rather than restrictive sense.

What is claimed is:

1. A system for performing memory management, comprising:
a page walker having an input to receive a first address, in which the page walker is to walk a hierarchical tree of page tables to identify the second address that corresponds to the first address; and
a page walker cache associated with the page walker to cache entries from one or more levels of the hierarchical tree.

2. The system of claim 1, in which the page walker cache comprises a first level page walker cache associated with a first level of the hierarchical tree.

3. The system of claim 2, in which the first level page walker cache is a static cache.

4. The system of claim 2, in which the first level page walker cache is to hold entries for a page global directory.

5. The system of claim 2, in which first level page walker cache hold pointers to entries in a second level of the hierarchical tree.

6. The system of claim 1, in which the page walker cache comprises a second level page walker cache associated with a second level of the hierarchical tree.

7. The system of claim 6, in which the second level page walker cache is to hold entries for a page directory.

8. The system of claim 6, in which second level page walker cache hold pointers to entries in a third level of the hierarchical tree.

9. The system of claim 6, in which the entries within the second level page walker cache are replaced using a Least Recently Used replacement policy.

10. The system of claim 1, in which the first address is a virtual address and the second address is a physical address.

11. A method implemented with a processor for performing memory management, comprising:
walking a hierarchical tree of page table entries to identify a second address that corresponds to a first address, the hierarchical tree having multiple levels of entries; and
accessing a page walker cache to walk the hierarchical tree, wherein the page walker cache is used to cache the entries for at least one level of the multiple levels of the hierarchical tree.

12. The method of claim 11, in which the first address is a virtual address and the second address is a physical address.

13. The method of claim 11, in which a cache miss determination is made that the page walker cache does not contain an entry needed to identify the second address, and wherein a page table structure is loaded to obtain the entry.

14. The method of claim 13, in which the entry is stored into the page walker cache.

15. The method of claim 14, in which an existing entry is removed from the page walker cache to provide space to store the entry.

16. The method of claim 15, in which the existing entry is identified for removal using a Least Recently Used replacement policy.

17. The method of claim 11, in which the page walker cache comprises a first level page walker cache associated with a first level of the hierarchical tree.

18. The method of claim 17, in which the first level page walker cache is a static cache.

19. The method of claim 17, in which the first level page walker cache is to hold entries for a page global directory.

20. The method of claim 17, in which first level page walker cache hold pointers to entries in a second level of the hierarchical tree.

21. The method of claim 17, in which the page walker cache further comprises a second level page walker cache associated with a second level of the hierarchical tree.

22. The method of claim 21, in which the second level page walker cache is to hold entries for a page directory.

23. The method of claim 21, in which second level page walker cache hold pointers to entries in a third level of the hierarchical tree.

24. The method of claim 21, in which the entries within the second level page walker cache are replaced using a Least Recently Used replacement policy.
